(19) United States
(12) Patent Application Publication
(10) Pub. No.: US 2019/0199867 A1
(43) Pub. Date: Jun. 27, 2019

(54) IMAGE FORMING APPARATUS

(71) Applicant: SHARP KABUSHIKI KAISHA, Osaka (JP)

(72) Inventor: MIKIYA OKADA, Sakai City (JP)

(21) Appl. No.: 16/231,409

(22) Filed: Dec. 22, 2018

(30) Foreign Application Priority Data
Dec. 27, 2017 (JP) 2017-251139

(51) Int. Cl. H04N 1/00; G06F 3/0488; H04W 4/80

(52) U.S. Cl. CPC H04N 1/00411; H04N 2201/0094; H04W 4/80; G06F 3/04886

(57) ABSTRACT

An image forming apparatus include an operation panel having an operation display that displays information. The operation panel includes a first operation key that receives a first operation command from a user, a second operation key that receives a second operation command from the user, and a near field communication unit that performs wireless communication with a portable terminal in a close range. The first operation key receives the first operation command when the first operation key is in a selection state, and the second operation key receives the second operation command when the selection state of the second operation key is released.

### BACKGROUND

### 1. Field

The present disclosure relates to an image forming apparatus that has a functionality to wirelessly communicate with a portable terminal.

### 2. Description of the Related Art

Image forming apparatuses that capture image data using a simple wireless communication system have been disclosed. Image forming apparatuses in the related art typically capture image data from an external portable terminal using a memory card. In near field communication (NFC) that is characteristic of a slow data speed, the disclosed image forming apparatus has a mechanism that captures from a portable terminal image data using preset WiFi (registered trademark) as a trigger for the transmission of the image data.

Communication is established by placing an NFC portable terminal and an image forming apparatus in a close range. During use, a communication region is arranged in an operation panel having an operation unit that gives a command to the image forming apparatus to centralize operations at a single point. The communication region is thus easily recognized.

When the portable terminal is placed close to the communication region located in the operation panel, there is a possibility that a user unintentionally touches the operation unit that gives a command to the image forming apparatus and enters an erratic input to the image forming apparatus.

Japanese Unexamined Patent Application Publication No. 2016-115046 discloses an image forming apparatus that controls an erratic input by detecting the presence of an object close to an NFC detector of a touch panel and thus by invalidating and rejecting an input within an area close to the NFC detector.

In the image forming apparatus disclosed in Japanese Unexamined Patent Application Publication No. 2016-115046, the touch region of the portable terminal is arranged in the center portion of an operation panel in the direction of depth, and thus at a location deeper than a key group including multiple keys. Portable terminals have recently become larger in scale, and if a portable terminal is held over the touch region, part of it covers the key group. If any of the keys detects the portable terminal before the presence of the portable terminal is detected, an erratic input may be input to the image forming apparatus and causes the image forming apparatus to perform a corresponding process.

It is desirable to provide an image forming apparatus that is free from an erratic operation in response to an unintended operation command performed in NFC communication.

### SUMMARY

According to an aspect of the disclosure, there is provided an image forming apparatus. The image forming apparatus include an operation panel having an operation display that displays information. The operation panel includes a first operation key that receives a first operation command from a user, a second operation key that receives a second operation command from the user, and a near field communication unit that performs wireless communication with a portable terminal in a close range. The first operation key in a selected state thereof receives the first operation command, and the second operation key in a deselected state thereof receives the second operation command.

### BRIEF DESCRIPTION OF THE DRAWINGS

FIG. 1 is a perspective view of a multifunction peripheral (MFP) of an embodiment;

FIG. 2 is a block diagram illustrating an electrical configuration of the MFP;

FIG. 3 is a plan view of an operation panel of a first embodiment;

FIG. 4 is an exploded perspective view of the operation panel of the first embodiment;

FIG. 5 is a perspective view of the operation panel of the first embodiment;

FIG. 6 is a perspective view of the operation panel of the first embodiment with a portable terminal held over the operation panel;

FIG. 7 is a timing diagram illustrating an input state of the operation panel of the first embodiment;

FIG. 8 is a timing diagram illustrating the state of an operation panel of a second embodiment;

FIG. 9 is a timing diagram illustrating the state of an operation panel of a third embodiment;

FIG. 10 is a perspective view of an operation panel of a fifth embodiment;

FIG. 11 is a perspective view of the operation panel of the fifth embodiment with a portable terminal held over the operation panel; and

FIG. 12 is a perspective view of the operation panel of the fifth embodiment with the portable terminal held over the operation panel.

### DESCRIPTION OF THE EMBODIMENTS

Embodiments of the disclosure are described below in connection with the drawings. For convenience of explanation, image forming apparatuses as multifunction peripherals (MFPs) are described as the embodiments. It will be understood that the embodiments also find applications in an image forming apparatus that includes a near field communication (NFC) unit and an operation panel serving as a touch panel.

### Structure Common to First Through Fifth Embodiments

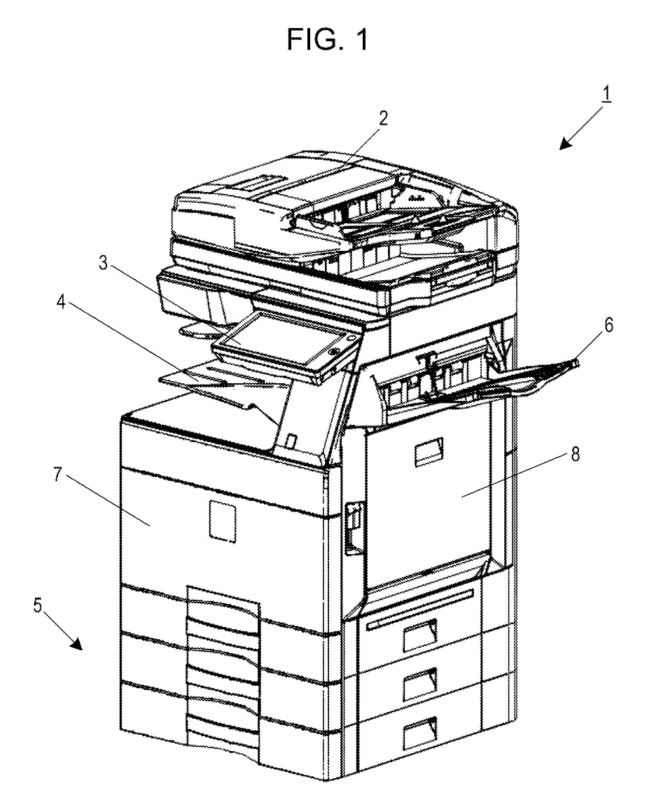

FIG. 1 is an external view of a multifunction peripheral (MFP) 1 of an embodiment of the disclosure.

The MFP 1 of FIG. 1 has functionalities to copy, to fax, to scan, and to store on server, and includes an automatic document feeder 2, an operation panel 3, a discharge paper tray 4, three paper feed trays 5, a manual feed tray 6, a front cover 7, and a right-side cover 8.

The automatic document feeder 2 causes document sheets to be read continuously by automatically feeding the set document sheets. A scanner is disposed in the transportation path of the document sheets, and each document sheet is read when it passes the scanner. Scanners may be vertically arranged such that a document sheet is transported between the scanners and the front and back sides of the document sheet are read at the same time.

The operation panel 3 has a functionality of an interface that gives a command to the MFP 1 when an operation command is received from the user. The operation panel 3 will be described in greater detail later.

The discharge paper tray 4 receives paper sheets discharged after being printed, and has space that accommodates a stack of printed paper sheets. The printed paper sheets may undergo a post-process (not illustrated) that sorts the printed paper sheets by discharging them to a right-hand side or a left-hand side of the discharge paper tray 4 according to job unit.

The three paper feed trays 5 receive paper sheets that are to be fed and printed. In this case, the paper feed trays 5 receive three types of paper sheets.

The manual feed tray 6 is used to set a paper sheet therein, and feeds to the MFP 1 the paper sheet other than the paper sheets set in the three paper feed trays 5.

The front cover 7 is pivoted open. The front cover 7 covers a power switch, a toner cartridge for printing, a printing unit, and the like mounted in the MFP 1.

The right-side cover 8 may be opened to remove a paper sheet if the paper sheet is jammed in the middle of printing.

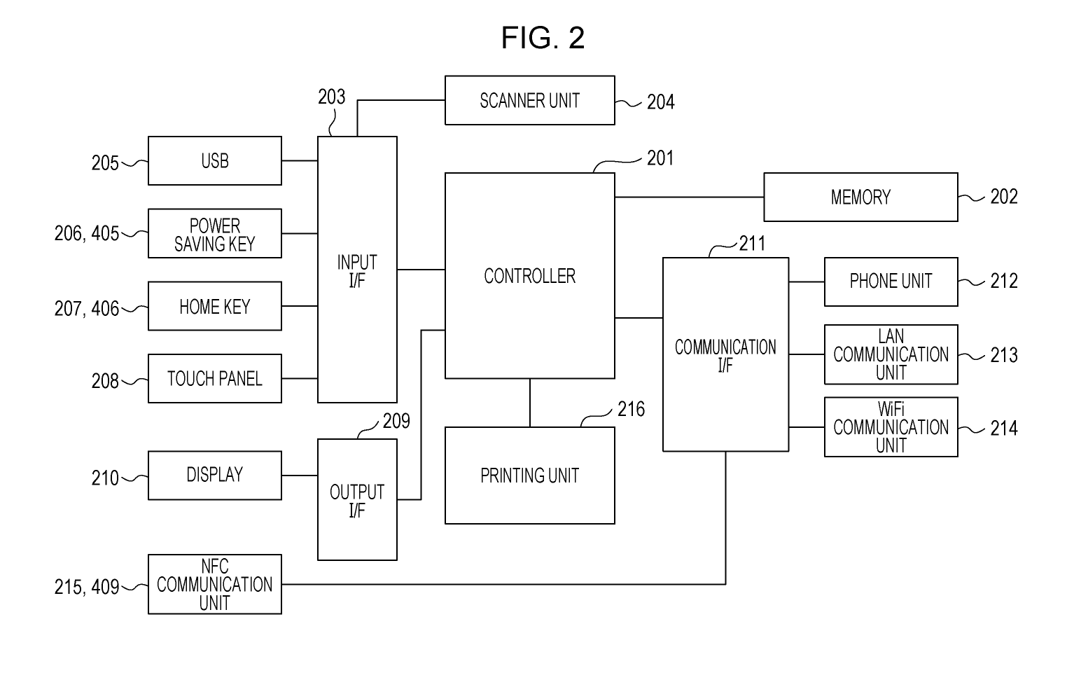

FIG. 2 is a functional block diagram of the MFP 1. A controller 201 controls elements of the whole MFP 1 in accordance with a program stored on a memory 202 discussed below. The controller 201 includes a high-speed memory serving as a work area of a central processing unit (CPU) that performs an arithmetic operation and gives commands.

The memory 202 includes a semiconductor memory, such as a hard disk drive (HDD) or a solid-state drive (SSD). The memory 202 pre-stores a program that controls the controller 201, and further stores in a non-volatile fashion a variety of settings made by a user.

An input interface (I/F) 203 receives signals from a variety of input units, including a scanner unit 204, a universal serial bus (USB) 205, a power saving key 206 (405), a home key 207 (406), and a touch panel 208, and transfers the signals to the controller 201.

The scanner unit 204 reads a document being transported by the automatic document feeder 2 of FIG. 1 or reads a document placed on a document platen, and includes an optical sensor, such as a charge-coupled device (CCD) image sensor.

A universal serial bus (USB) 205 is an interface (I/F) that is connected to an external memory (such as a USB memory). According to the embodiment, the USB 205 reads data from or writes data to the USB memory.

A power saving key 206(405) is used to give a command to shift the MFP 1 to a power saving mode to save power. The power saving key 206 detects an operation performed by a user by detecting a change in capacitance. In order not to shift to the power saving mode in response to an erratic touch, the power saving key 206 thus allows the MFP 1 to shift to the power saving mode after a time elapse of 1 second, for example.

A home key 207(406) is used to change an operation screen to a screen on which a variety of functionalities of the MFP 1 is selected. Like the power saving key 206, the home key 207 detects an operation performed by the user by detecting a change in capacitance. But if the home key 207 is designed to be activated after a time elapse like the power saving key 206, this inconveniences the user. The home key 207 is designed to immediately change one screen to another when it is operated.

The power saving key 206 and the home key 207 are activated when each of these keys is selected by touching. The selection mechanism is not limited to touching. For example, the selection mechanism may be implemented using a hardware key.

A touch panel 208 is based on an analog resistive membrane system, and is arranged on a display 210 described below. The touch panel 208 is used to detect an input to a location on the display 210.

The touch panel 208 is not limited to the analog resistive membrane system that uses a divided voltage. Alternatively, the touch panel 208 may be an electrostatic capacity system that detects a change in capacitance present between a finger and a pattern, an infrared ray blocking system that uses an area that blocks a radiated infrared ray, or a camera system that identifies a location in response to a shadow of a finger which is photographed by a camera.

An output I/F 209 is used to output to the user a signal output from the controller 201. The output I/F 209 converts the signal from the controller 201 into information that is to be displayed on a bitmap (not illustrated), and generates a driving signal and supplies to the display 210 the driving signal to drive the display 210.

The display 210 is used to provide the user with information, and is a flat display, such as a liquid-crystal display or an electroluminescent (EL) display.

A communication interface (I/F) 211 relays communication between the MFP 1 and an external device. The communication I/F 211 connects to a phone unit 212 that performs a facsimile communication using a telephone network, a local-area network (LAN) communication unit 213 that performs email communication using the Internet, a WiFi communication unit 214 that performs high-speed wireless communication within a coverage of several tens meters, and an NFC communication unit 215(409) that performs relatively short-range wireless communication.

The NFC communication unit 215 has a near field communication functionality unit that performs wireless communication with a terminal device (portable terminal) within a close range.

A printing unit 216 prints an image on a paper sheet placed in one of the three paper feed trays 5 or the manual feed tray 6 illustrated in FIG. 1 by fixing toner onto the paper sheet using heat and pressure.

### First Embodiment

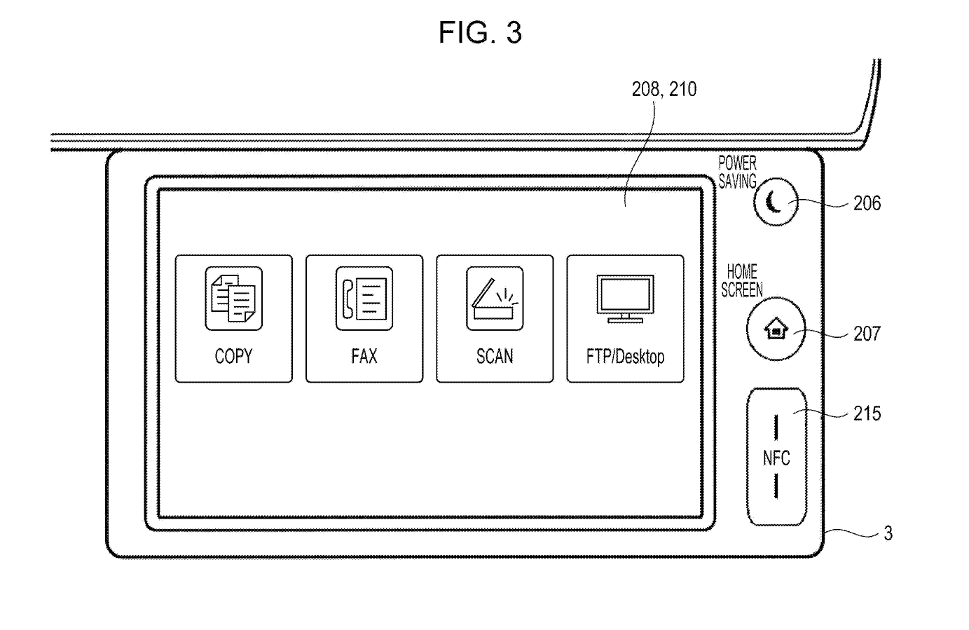

A first embodiment is described. FIG. 3 illustrates the operation panel 3. Elements illustrated in FIG. 3 and related to the elements illustrated in FIG. 1 and FIG. 2 are designated with the same reference numerals, and the discussion thereof is omitted as appropriate.

A touch screen having the touch panel 208 on the display 210 is arranged in the center portion of the operation panel 3. In the example of FIG. 3, the display 210 displays four icons indicating a copy functionality, a fax functionality, a scan functionality, and FTP/Desktop functionality. When the user touches one of the displayed icons, the touch panel 208 detects a touch location, and the functionality corresponding to the icon displayed at the touch location is performed.

Arranged to the right of the touch screen in the order of the deeper side toward the front side of the operation panel 3 are a region that is used to detect the power saving key 206, a region that is used to detect the home key 207, and a region that is used to perform communication using the NFC communication unit 215.

The first embodiment is characteristic of the arrangement in which a communication region of the NFC communication unit 215 serving as an NFC interface that performs NFC communication is arranged closer to the user of the operation panel 3. In other words, the communication region of the NFC communication unit 215 is arranged in the extension line of the power saving key 206 and the home key 207.

If viewed from the user who operates the operation panel 3 (viewed from the lower side of FIG. 3), the communication region of the NFC communication unit 215 is arranged closer to the user than the operation region where operation keys, such as the power saving key 206 and the home key 207, are arranged. The communication region of the NFC communication unit 215 is desirably arranged near one corner of the operation panel 3. The communication region of the NFC communication unit 215, if not arranged near the corner of the operation panel 3, is desirably arranged below the operation region in FIG. 3.

The touch panel 208, the operation region (the power saving key 206 and the home key 207), and the communication region of the NFC communication unit 215 are arranged on the same surface plane of the operation panel 3. A user friendly operation panel thus results by providing these elements on the same surface plane.

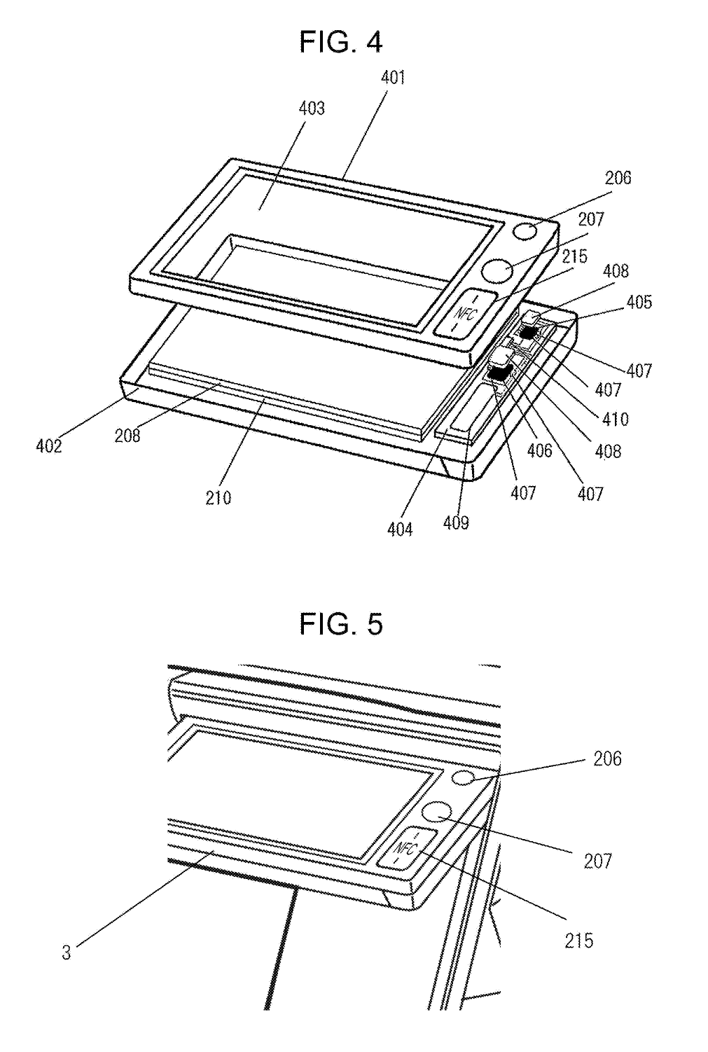

FIG. 4 is the perspective view of the operation panel 3. The operation panel 3 includes a combination of an upper frame 401 and a lower frame 402. The operation panel 3 is pivotally connected to the MFP 1 about a rotary shaft (not illustrated) on the rear side of the lower frame 402.

The upper frame 401 includes a window 403 that is space defined by the upper frame 401 itself. Through the window 403, the user checks the display 210 in the operation panel 3 concerning the touch panel 208 and the display 210, and performs a touch operation to the touch panel 208.

A substrate 404 is arranged beside the display 210 and the touch panel 208. The substrate 404 includes a first static electricity detector 405 serving as the power saving key 206 and a second static electricity detector 406 serving as the home key 207. The first static electricity detector 405 and the second static electricity detector 406 detect a change in capacitance responsive to an operation performed by the user.

Light-emitting diodes (LEDs) 407 are arranged on both sides of each of the patterns of the first static electricity detector 405 and the second static electricity detector 406. Light guide plates 408 are arranged on the patterns of the first static electricity detector 405 and the second static electricity detector 406 to guide light upward from the LEDs 407 in a manner such that the detection of capacitance is not affected.

Light guided by the light guide plate 408 is recognized from above because the corresponding target region of the upper frame 401 is translucent. The key location is thus easily recognized.

In accordance with the first embodiment, the power saving key 206 and the home key 207 are electrostatic capacity switches that detect operation inputs by detecting capacitance. Alternatively, each of the power saving key 206 and the home key 207 may be a simple pressure sensitive switch or a simple mechanical switch. Alternatively, the power saving key 206 and the home key 207 may be a combination of these switches. For example, the home key 207 may be an electrostatic capacity switch and the power saving key 206 may be a mechanical switch.

The switches arranged in the operation region are the power saving key 206 and the home key 207. But these switches may be implemented as a single switch. Alternatively, the operation region may have no switch at all. For example, the functionalities of the switches may be additionally performed by another switch, such as a clear key, a mode switching key, or a power key. Such a switch may have the functionalities of the switches as well as its own functionality.

The substrate 404 includes a loop antenna 409 in the form of a wiring pattern to perform wireless NFC communication. The loop antenna 409 serves as an input and output unit that works with a terminal device, such as a smart phone performing the NFC communication.

A variety of components mounted on the substrate 404 are connected with an input interface (I/F) 203 and the communication I/F 211 via a connector 410 and as a result, the controller 201 performs processes thereof.

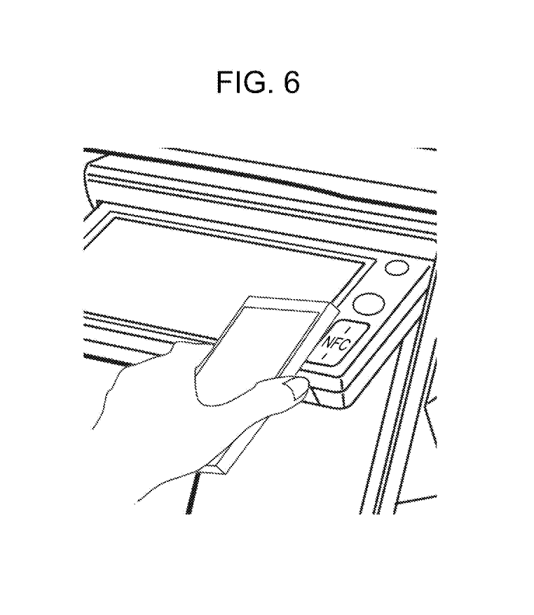

FIG. 5 is the perspective view of the operation panel 3. When the user causes the portable terminal to communicate with the MFP 1, the user places the portable terminal close to communication coverage of the NFC communication unit 215 as illustrated in FIG. 6.

Since the region of the NFC communication unit 215 is the front portion of the upper frame 401, the user may be able to hold the portable terminal over the MFP 1 in a manner such that the portable terminal does not cover the power saving key 206 and the home key 207. This is contrasted with the case in which the NFC communication unit 215 is arranged in a central or deeper portion of the upper frame 401.

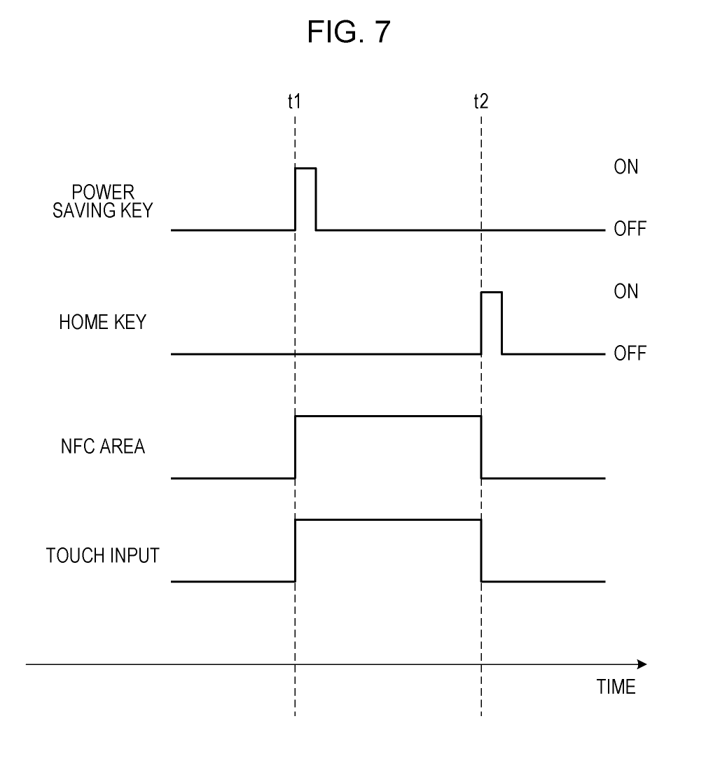

Operation input and communication control on detection regions of the power saving key 206, the home key 207, and the NFC communication unit 215 are described in connection with FIG. 7. FIG. 7 illustrates the detection of the touch input and operation signals.

The horizontal axis of FIG. 7 represents time. FIG. 7 illustrates touch inputs entered from time t1 when a touch input from the user is detected to time t2 when the touch input is deactivated, a communication enabled state, and timings of operation commands. The power saving key 206 outputs the operation command (operation signal ON) immediately subsequent to the touch input. In contrast, the home key 207 outputs the operation command (operation signal ON) when the touch input is no longer detected (for example, when a finger lifts off) after the touch input has been detected.

The NFC communication unit 215 remains in a communication enabled state while the touch input remains on. More specifically, the communication enabled state continues immediately subsequent to the touch input.

An erratic operation is thus avoided by changing the timing of the operation command (operation input) between the startup of the detection of the touch input and the end of the detection of the touch input. For example, even if the home key 207 is touched when the portable terminal is held over the region of the NFC communication unit 215, an operation command responsive to an erratic operation is avoided.

### Second Embodiment

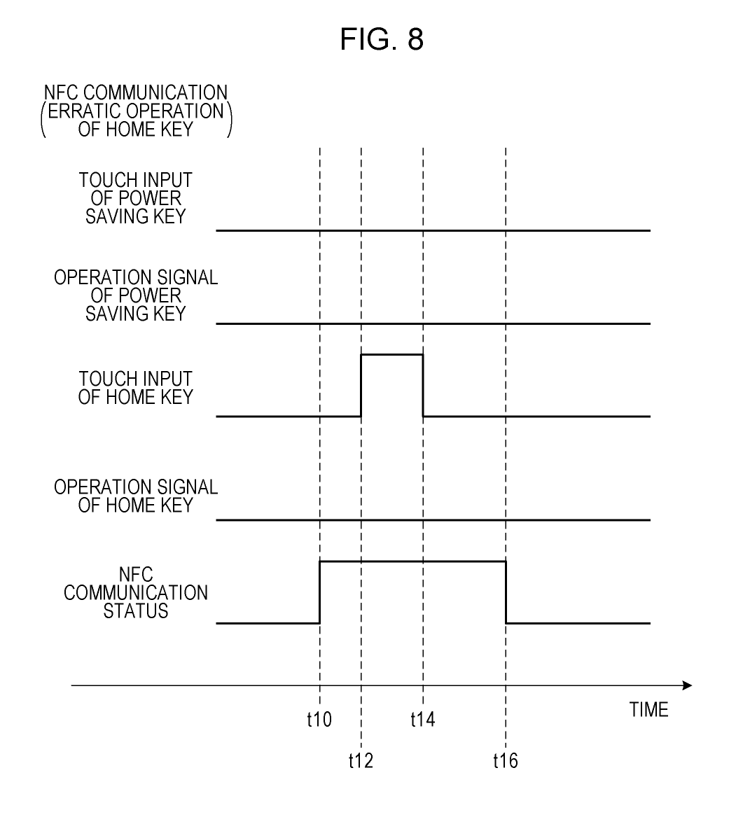

A second embodiment is described in connection with FIG. 8.

In accordance with the second embodiment, even if the home key 207 is touched with the NFC communication unit 215 communicating, an indication that the operation command has been input is not output (the operation signal is not turned on).

The NFC communication unit 215 may now perform the NFC communication from time t10 to time t16. In other words, the portable terminal is being held over the NFC communication unit 215.

The portable terminal or a finger of the user may touch the home key 207 (during a time period from time t12 to time t14). In this case, the home key 207 could output the operation command (the operation signal of the home key 207 could turn on). However, since the NFC communication unit 215 detects the NFC communication, the operation command from the home key 207 is regarded as not being output. More specifically, the operation signal of the home key 207 remains to be off.

In accordance with the second embodiment, the home key 207 does not output the operation command while the NFC communication is performed. In other words, the operation signal of the home key 207 remains to be off, and an erratic operation command is avoided during the NFC communication.

### Third Embodiment

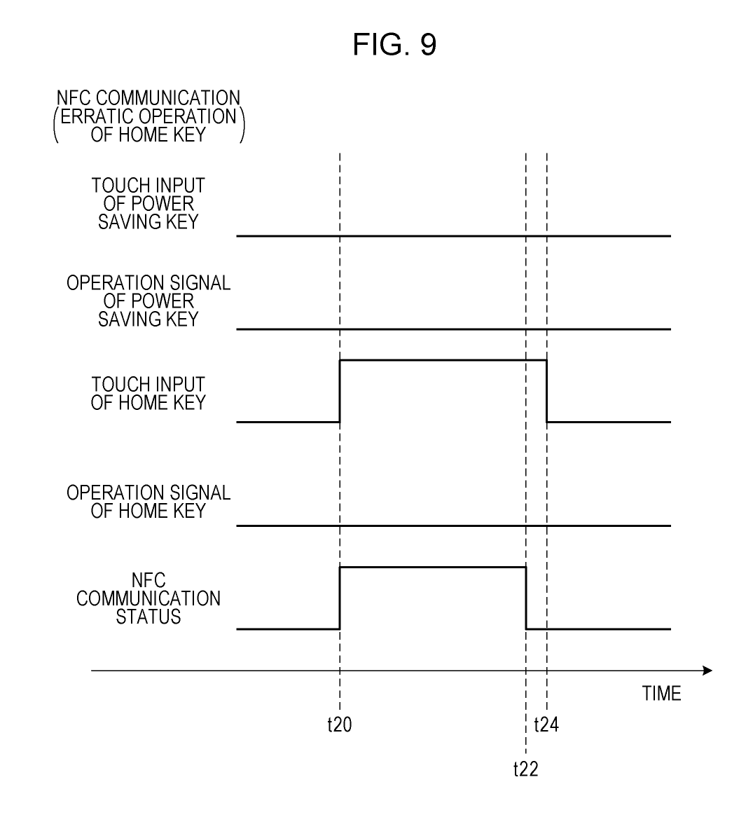

A third embodiment is described in connection with FIG. 9.

In accordance with the third embodiment, the NFC communication unit 215 does not receive from the operation command from the home key 207 for a predetermined period of time after the communication of the NFC communication unit 215.

Referring to FIG. 9, the portable terminal performs the NFC communication via the NFC communication unit 215 from time t20 to time t22.

Even if the touch input on the home key 207 is detected, and the touch input on the home key 207 is then deactivated after the communication of the NFC communication unit 215, the operation command is not accepted from the home key 207. In other words, the ON operation signal is not output.

Even if the touch input of the home key 207 is deactivated (time t24) during a predetermined period of time, such as 0.5 seconds, 1 second, or 2 seconds after the completion of the NFC communication, the operation signal of the home key 207 remains to be off.

In this way, an erratic operation command is avoided even if the home key 207 is touched when the portable terminal held over the NFC communication unit 215 is removed.

### Fourth Embodiment

A fourth embodiment is described in connection with FIG. 9.

If the touch input to the home key 207 has continued for a predetermined period of time or longer in the fourth embodiment, no operation command is received from the home key 207.

If the home key 207 is erratically touched while communication is performed with the portable terminal held over the communication region of the NFC communication unit 215, a touch input to the home key 207 is detected.

If the touch operation on the home key 207 has continued for the predetermined period of time or longer, the operation command is not received even when the touch operation stops. The operation signal is in the off state.

The predetermined period of time is a fixed period of time or longer, for example, 1 second or longer, or 3 seconds or longer.

A determination is made as to whether the NFC communication unit 215 is currently in the communication state with the portable terminal (or the NFC communication unit 215 has been in the communication state with the portable terminal). If the NFC communication unit 215 is in the communication state with the portable terminal, no operation command may be received, and the operation signal may be set to be off.

### Fifth Embodiment

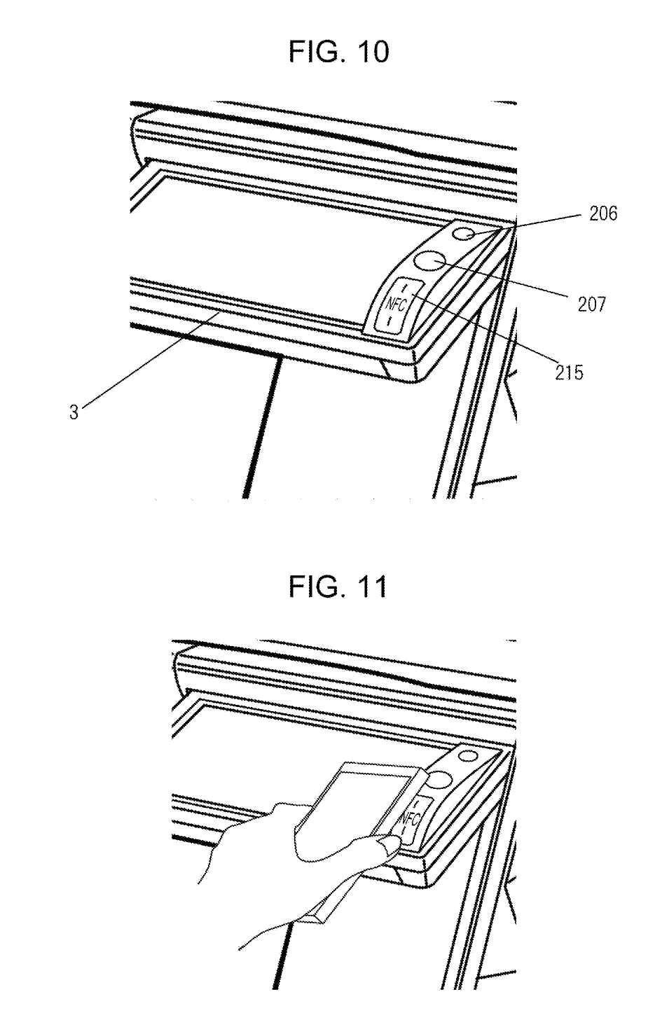

A fifth embodiment is described below in connection with FIGS. 10, 11, and 12. In addition to the features of the embodiments described above, the fifth embodiment has a characteristic shape to avoid an erratic operation.

The fifth embodiment is identical to the first embodiment in that the region of the NFC communication unit 215 is arranged on the surface of the operation panel 3, but is different from the first embodiment that the region is inclined.

In accordance with the fifth embodiment, the operation panel 3 has a gradually rising slope extending from the front side of the operation panel 3 toward a deeper portion (the center point), and the communication region of the NFC communication unit 215 is thus arranged on the front portion from the peak of the rising slope toward the front side. The operation regions of the power saving key 206 and the home key 207 other than the NFC communication unit 215 are arranged in the gradually falling slope extending from the peak of the rising slope toward the deeper side of the operation panel 3.

The communication region of the NFC communication unit 215 is mounted on the rising slope from the front side toward the deeper portion of the operation panel 3 while the operation regions are mounted on the slope at an angle different from the angle of the rising slope of the operation panel 3.

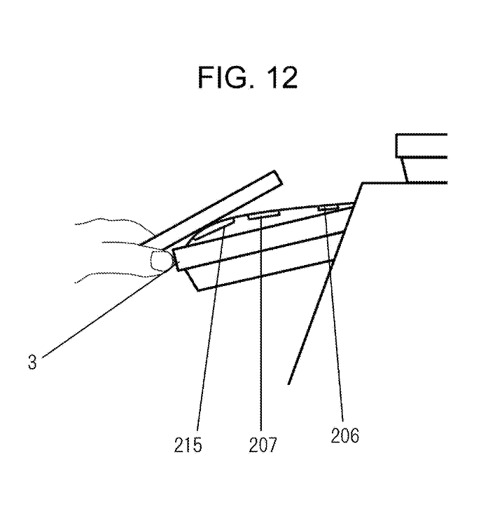

The communication region and the operation regions are arranged in this way as illustrated in FIG. 12. Even if the portable terminal is held at a location that reaches the area of the home key 207, possibly causing erratic detection in response to a change in capacitance, spacing is assured to the keys, and the erratic detection is thus controlled.

In the fifth embodiment, the rising slope is arranged in the direction extending from the front side toward the deeper side of the operation panel 3. The direction may be a lateral direction. More specifically, a first gradually rising slope may be arranged from the right side toward the center portion of the operation panel 3. A second gradually falling slope may be arranged from the center portion toward the right side on the operation panel 3. The communication region may be arranged on the first slope, and the operation regions may be arranged on the second slope.

The communication region and the operation regions may be reversed in position. For example, the operation regions may be arranged on the front portion, and the communication region may be arranged on the deeper portion. Because of the presence of the slope, even if the portable terminal is held over the NFC communication unit 215, the portable terminal may touch the NFC communication unit 215 at an angle different from the angle at which the portable terminal touches the power saving key 206 or the home key 207. An erratic operation is thus controlled.

### Modifications

The embodiments of the disclosure have been described. The disclosure is not limited to the embodiments. Designs that do not depart from the scope of the disclosure fall within the range defined by the claims.

The MFPs have been described as an example of the image forming apparatus in the embodiments. The embodiments may find applications in a facsimile device alone, a printer alone, or a copying machine alone.

In accordance with the embodiments, the NFC communication unit is used to communicate with the portable terminal. The embodiments may be used in another type of near field communication. For example, the embodiments may be used in communication where an authentication card is used using radio frequency identifier (RFID).

The present disclosure contains subject matter related to that disclosed in Japanese Priority Patent Application JP 2017-251139 filed in the Japan Patent Office on Dec. 27, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus comprising an operation panel having an operation display that displays information, the operation panel including a first operation key that receives a first operation command from a user, a second operation key that receives a second operation command from the user, and a near field communication unit that performs wireless communication with a portable terminal in a close range,
wherein the first operation key receives the first operation command when the first operation key is in a selection state, and the second operation key receives the second operation command when a selection state of the second operation key is released.

2. The image forming apparatus according to claim 1, wherein the second operation key does not receive the second operation command while the near field communication unit wirelessly communicates with the portable terminal.

3. The image forming apparatus according to claim 1, wherein the second operation key does not receive the second operation command during a predetermined period of time after the near field communication unit completes communication.

4. The image forming apparatus according to claim 1, wherein as long as the selection state of the second operation key continues for a predetermined period of time or longer, the second operation key does not receive the second operation command even if the selection state thereof is released.

5. The image forming apparatus according to claim 1, where the operation panel includes the first operation key, the second operation key, and the near field communication unit which are arranged along a straight line.
